(19) United States
(12) Patent Application Publication
(10) Pub. No.: US 2019/0193293 A1
(43) Pub. Date: Jun. 27, 2019

(54) SHAVING AID DISPENSING RAZOR ASSEMBLY

(71) Applicant: Sharon Peach, Woodhaven, NY (US)

(72) Inventor: Sharon Peach, Woodhaven, NY (US)

(21) Appl. No.: 15/855,302

(22) Filed: Dec. 27, 2017

(51) Int. Cl. B26B 21/44; B26B 21/52; B26B 21/22

(52) U.S. Cl. CPC B26B 21/446; B26B 21/521; B26B 21/222; B26B 21/522

(57) ABSTRACT

A shaving aid dispensing razor assembly for convenient shaving includes a tube that defines an interior space. The tube has a first end that is closed and a second end that is open. Each of a plurality of cutting modules is selectively couplable to the second end of the tube so that the cutting module is in fluidic communication with the interior space. A shaving aid is positioned in the interior space. The tube is configured to be grasped in a user's hand to position a respective cutting module next to a skin surface that is to be shaved. An actuator that is coupled to the tube is positioned to motivate the shaving aid through the second end and the cutting module to apply the shaving aid to the skin surface. The user is positioned to motivate the cutting module across the skin surface to shave the skin surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shaving assemblies and more particularly pertains to a new shaving assembly for convenient shaving.

### BRIEF SUMMARY OF THE INVENTION

An embodiment of the disclosure meets the needs presented above by generally comprising a tube that defines an interior space. The tube has a first end that is closed and a second end that is open. Each of a plurality of cutting modules is selectively couplable to the second end of the tube so that the cutting module is in fluidic communication with the interior space. A shaving aid is positioned in the interior space. The tube is configured to be grasped in a user's hand to position a respective cutting module next to a skin surface that is to be shaved. An actuator that is coupled to the tube is positioned to motivate the shaving aid through the second end and the cutting module to apply the shaving aid to the skin surface. The user is positioned to motivate the cutting module across the skin surface to shave the skin surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a shaving aid dispensing razor assembly according to an embodiment of the disclosure.

FIG. 2 is an isometric perspective view of an embodiment of the disclosure.

FIG. 3 is a cross-sectional view of an embodiment of the disclosure.

FIG. 4 is a cross-sectional view of an embodiment of the disclosure.

### DETAILED DESCRIPTION OF THE INVENTION

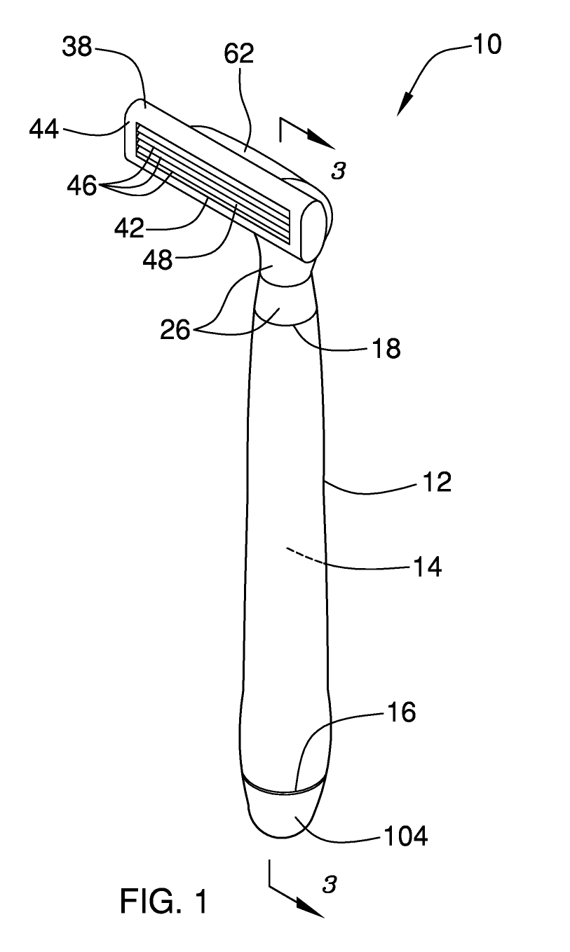

With reference now to the drawings, and in particular to FIGS. 1 through 4 thereof, a new shaving assembly embodying the principles and concepts of an embodiment of the disclosure and generally designated by the reference numeral 10 will be described.

As best illustrated in FIGS. 1 through 4, the shaving aid dispensing razor assembly 10 generally comprises a tube 12 that defines an interior space 14. The tube 12 has a first end 16 that is closed and a second end 18 that is open. The tube 12 has an inner circumference 20 that is non-circularly shaped. The inner circumference 20 is ovally shaped or the like. The tube 12 has an outer circumference 22 that is larger proximate to the first end 16 to define a protuberance 24. The protuberance 24 is configured to deter slippage of a hand that grasps the tube 12.

The assembly 10 comprises a housing 26 that has a bottom 28 that is selectively couplable to the second end 18 of the tube 12. A first channel 30 extends between a top 32 and the bottom 28 of the housing 26. The first channel 30 is aligned with the second end 18 of the tube 12.

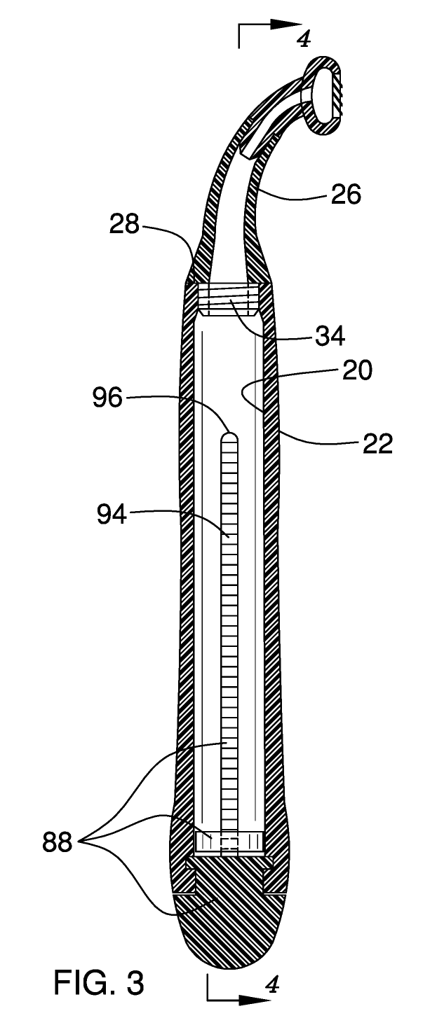

A first pipe 34 is coupled to and extends from the bottom 28 of the housing 26. The first pipe 34 is aligned with the first channel 30. The first pipe 34 is in fluidic communication with the first channel 30. The first pipe 34 is externally threaded, as shown in FIG. 3. The inner circumference 20 is circularly shaped adjacent to the second end 18. The tube 12 is internally threaded adjacent to the second end 18. The first pipe 34 is positioned to be threadedly inserted into the second end 18 of the tube 12 to reversibly couple the housing 26 to the tube 12 so that the housing 26 is in fluidic communication with the first channel 30.

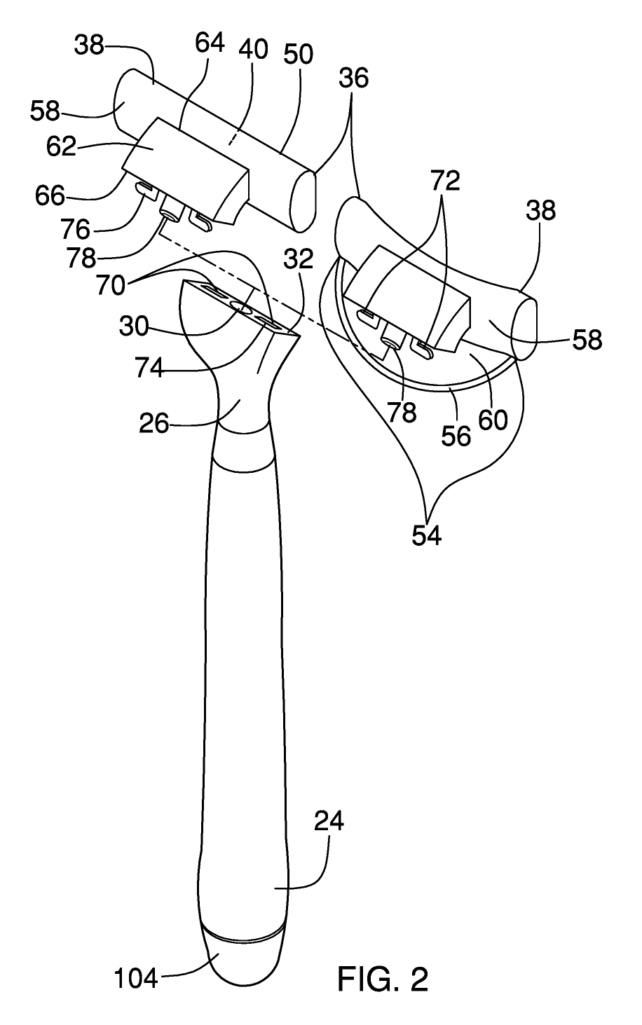

Each of a plurality of cutting modules 36 is selectively couplable to the second end 18 of the tube 12, as shown in FIG. 2. The cutting module 36 is in fluidic communication with the interior space 14. Each cutting module 36 comprises a shell 38 that defines an internal space 40. An aperture 42 is positioned in a front face 44 of the shell 38. A plurality of blades 46 is coupled to the shell 38 and is positioned in the internal space 40 so that a cutting edge 48 of the blade 46 protrudes from the front face 44 through the aperture 42, as shown in FIG. 1. The blades 46 are parallel planarly positioned. The plurality of blades 46 comprises from one to five blades 46. The plurality of blades 46 comprises from two to four blades 46. The plurality of blades 46 comprises four blades 46.

The plurality of cutting modules 36 comprises a first module 50 and a second module 52, as shown in FIG. 2. The front face 44 of the shell 38 of the first module 50 is substantially planar. The front face 44 of the shell 38 of the second module 52 is concavely arcuate. Each cutting edge 48 of the plurality of blades 46 that is positioned in the shell 38 of the second module 52 is arcuate so that the plurality of blades 46 is complementary to the front face 44 of the shell 38 of the second module 52. The front face 44 of the shell 38 of the second module 52 facilitates shaving of curved skin surfaces, such that the head.

Each of opposing endpoints 54 of a strap 56 is coupled to a back face 58 proximate to a respective opposing end 106 of the shell 38 of the second module 52 to defines a loop 60, as shown in FIG. 2. The loop 60 is configured to insert digits of the hand of the user. The user is positioned to motivate the plurality of blades 46 that is positioned in the shell 38 of the second module 52 across the skin surface to shave the skin surface.

A bar 62 that has a first face 64 is coupled to the back face 58 of the shell 38. The bar 62 has a second face 66 that is configured to couple to the top 32 of the housing 26. The housing 26 and bar 62 are arcuate so that the housing 26 and the bar 62 are curvedly positioned between the tube 12 and the back face 58 of the shell 38, as shown in FIG. 3. A second channel 68 extends through the bar 62 between the first face 64 and the second face 66. The second channel 68 is aligned with the first channel 30 when the bar 62 is coupled to the housing 26 so that internal space 40 of the shell 38 is in fluidic communication with the interior space 14 of the tube 12.

A plurality of first couplers 70 is coupled to the top 32 of the housing 26. A plurality of second couplers 72 is coupled to the second face 66 of the bar 62, as shown in FIG. 2. The second couplers 72 are complementary to the first couplers 70. Each second coupler 72 is positioned to selectively couple to a respective first coupler 70 to couple the bar 62 to the housing 26. The plurality of first couplers 70 comprises two first couplers 70. Each first coupler 70 comprises a slot 74 that extends into the top 32 of the housing 26. Each second coupler 72 comprises a tab 76. The tab 76 is L-shaped, resilient, and deformable. Each tab 76 is positioned to selectively insert into a respective slot 74 to couple the bar 62 to the housing 26.

A second pipe 78 is coupled to and extends from the second face 66 of the bar 62, as shown in FIG. 2. The second pipe 78 is complementary to the first channel 30. The second pipe 78 is positioned to be sealably inserted into the first channel 30 as the bar 62 is coupled to the housing 26. The internal space 40 of the shell 38 is in fluidic communication with the interior space 14 of the tube 12.

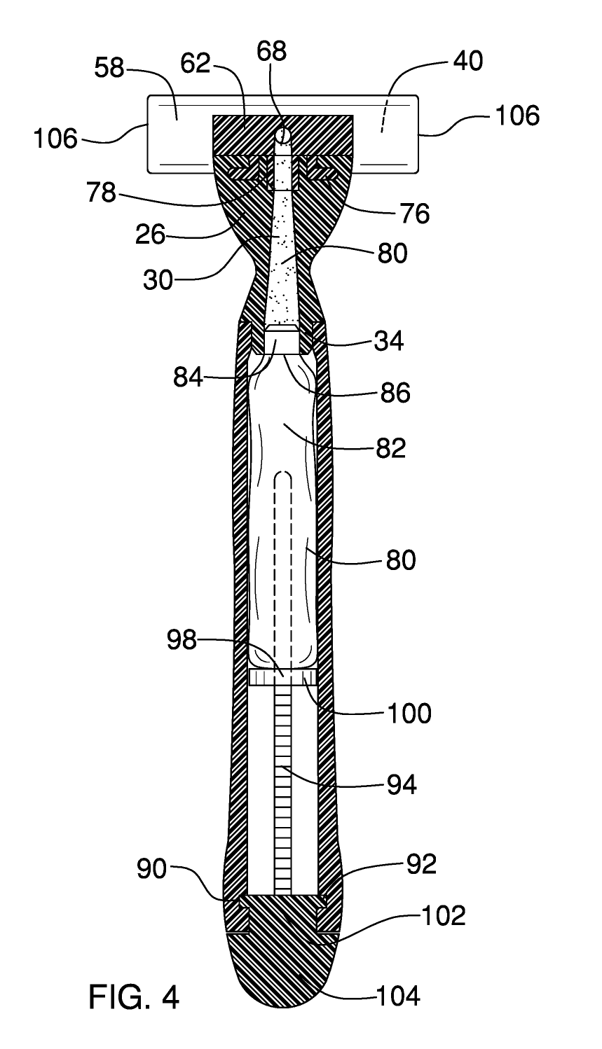

A shaving aid 80, such as a gel, cream, lotion, or the like, is positioned in the interior space 14. The shaving aid 80 is positioned in a sleeve 82 that is complementary to the interior space 14, as shown in FIG. 4. The sleeve 82 is flexible so that the sleeve 82 is configured to be selectively compressed to apply pressure to the shaving aid 80. A nipple 84 is coupled to an upper end 86 of the sleeve 82. The first pipe 34 is configured to insert the nipple 84 to couple the sleeve 82 to the housing 26. The housing 26 is configured to be decoupled from tube 12 to replace the shaving aid 80 upon depletion.

An actuator 88 is coupled to the tube 12. The actuator 88 is configured to selectively motivate the shaving aid 80 from the first end 16 to the second end 18 of the tube 12 so that the shaving aid 80 exits through the cutting module 36. The tube 12 is configured to be grasped in the hand of the user to position the user to position a respective cutting module 36 next to a skin surface that is to be shaved. The actuator 88 is positioned to motivate the shaving aid 80 through both the second end 18 and the respective cutting module 36 and to apply the shaving aid 80 to the skin surface. The user is positioned to motivate the respective cutting module 36 across the skin surface to shave the skin surface.

The actuator 88 comprises a cutout 90 that extends into the tube 12 from the inner circumference 20 proximate to the first end 16, as shown in FIGS. 3 and 4. The cutout 90 extends annularly around the inner circumference 20 and is circularly shaped. A first disk 92 is positioned in the cutout 90. The first disk 92 is rotatable relative to the tube 12. A rod 94 is coupled to and extends from the first disk 92 into the interior space 14. The rod 94 is threaded. The rod 94 has a terminus 96 distal from the first disk 92. The terminus 96 is rounded. The sleeve 82 is deformable around the rod 94 as the sleeve 82 is inserted into the interior space 14. The present invention also anticipates that the sleeve 82 may be formed to accommodate insertion of the rod 94.

An orifice 98 is centrally positioned through a second disk 100. The second disk 100 is substantially complementary to the inner circumference 20 of the tube 12. The orifice 98 is threaded and complementary to the rod 94. The rod 94 is threadedly inserted through the orifice 98.

A cylinder 102 is coupled to and extends from the first disk 92 through the first end 16 of the tube 12. A knob 104 is coupled to the cylinder 102 distal from the first disk 92. The knob 104 is external to the tube 12. The knob 104 is configured to be grasped in digits of the hand of the user to selectively impart rotation to the knob 104 concurrent with rotation of the cylinder 102, the first disk 92, and the rod 94. The second disk 100 is selectively positionable between the first end 16 and the second end 18 of the tube 12 to apply pressure to the shaving aid 80 that is positioned in the sleeve 82. The shaving aid 80 is motivated through the first channel 30, the second channel 68, and the shell 38 to apply the shaving aid 80 to the skin surface.

In use, the tube 12 is configured to be grasped in the hand of the user to position the user to position the respective cutting module 36 next to the skin surface to be shaved.

The knob 104 is configured to be grasped in the digits of the hand of the user to selectively impart rotation to the knob 104 to apply pressure to the shaving aid 80 that is positioned in the sleeve 82. The shaving aid 80 is motivated through the first channel 30, the second channel 68, and the shell 38 to apply the shaving aid 80 to the skin surface. The user is positioned to motivate the respective cutting module 36 across the skin surface to shave the skin surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shaving aid dispensing razor assembly comprising:
a tube defining an interior space, said tube have a first end and a second end, said first end being closed, said second end being open;
a plurality of cutting modules, each said cutting module being selectively couplable to said second end of said tube such that said cutting module is in fluidic communication with said interior space;
a shaving aid positioned in said interior space;
an actuator coupled to said tube, said actuator being configured for selectively motivating said shaving aid from said first end to said second end of said tube such that said shaving aid exits through said cutting module; and
wherein said tube is configured for grasping in a hand of the user positioning the user for positioning a respective said cutting module next to a skin surface to be shaved such that said actuator is positioned for motivating said shaving aid through said second end and said respective said cutting module and for applying said shaving aid to the skin surface, such that the user is positioned for motivating said respective said cutting module across the skin surface for shaving the skin surface.

2. The assembly of claim 1, further comprising:
a housing having a bottom selectively couplable to said second end of said tube;
a first channel extending between a top and said bottom of said housing such that said first channel is aligned with said second end of said tube; and
said cutting modules being selectively couplable to said top of said housing such that said cutting module is in fluidic communication with said first channel.

3. The assembly of claim 2, further comprising:
said tube having an inner circumference, said inner circumference being circularly shaped adjacent to said second end, said tube being internally threaded adjacent to said second end;
a first pipe coupled to and extending from said bottom of said housing, said first pipe being aligned with said first channel such that said first pipe is in fluidic communication with said first channel, said first pipe being externally threaded; and
wherein said first pipe is positioned for threadedly inserting into said second end of said tube for reversibly coupling said housing to said tube and such that said housing is in fluidic communication with said first channel.

4. The assembly of claim 2, further comprising:
each said cutting module comprising:
a shell defining an internal space,
an aperture positioned in a front face of said shell,
a plurality of blades, each said blade being coupled to said shell and positioned in said internal space such that a cutting edge of said blade protrudes from said front face through said aperture,
a bar having a first face coupled to a back face of said shell, said bar having a second face configured for coupling to said top of said housing, and
a second channel extending through said bar and between said first face and said second face; and
wherein said second channel is positioned through said bar such that said second channel is aligned with said first channel when said bar is coupled to said housing such that said internal space said shell is in fluidic communication with said interior space of said tube.

5. The assembly of claim 4, further including said plurality of cutting modules comprising a first module, said front face of said shell of said first module being substantially planar.

6. The assembly of claim 4, further comprising:
said plurality of cutting modules comprising a second module, said front face of said shell of said second module being concavely arcuate, each said cutting edge of said plurality of blades positioned in said shell of said second module being arcuate such that said plurality of blades is complementary to said front face of said shell of said second module;
a strap having opposing endpoints, each said opposing endpoint being coupled to said back face proximate to a respective opposing end of said shell of said second module defining a loop; and
wherein said strap is positioned on said shell of said second module such that said loop is configured for inserting digits of the hand of the user such that the user is positioned for motivating said plurality of blades positioned in said shell of said second module across the skin surface for shaving the skin surface.

7. The assembly of claim 4, further including said blades being parallel planarly positioned, said plurality of blades comprising from one to five said blades.

8. The assembly of claim 7, further including said plurality of blades comprising from two to four said blades.

9. The assembly of claim 8, further including said plurality of blades comprising four said blades.

10. The assembly of claim 4, further including said housing and bar being arcuate such that said housing and said bar are curvedly positioned between said tube and said back face of said shell.

11. The assembly of claim 4, comprising:
a plurality of first couplers coupled to said top of said housing, said plurality of first couplers comprising two said first couplers;
a plurality of second couplers coupled to said second face of said bar, said second couplers being complementary to said first couplers; and
wherein said second couplers are positioned on said bar such that each said second coupler is positioned for selectively coupling to a respective said first coupler for coupling said bar to said housing.

12. The assembly of claim 11, further comprising:
each said first coupler comprising a slot extending into said top of said housing;
each said second coupler comprising a tab, said tab being resilient such that said tab is deformable, said tab being L-shaped; and
wherein said tabs are positioned on said bar such that each said tab is positioned for selectively inserting into a respective said slot for coupling said bar to said housing.

13. The assembly of claim 4, further including a second pipe coupled to and extending from said second face of said bar, said second pipe being complementary to said first channel, wherein said second pipe is positioned on said bar such that said second pipe is positioned for sealably inserting into said first channel as said bar is coupled to said housing such that said internal space of said shell is in fluidic communication with said interior space of said tube.

14. The assembly of claim 1, further including said shaving aid being positioned in a sleeve, said sleeve being complementary to said interior space, said sleeve being flexible such that said sleeve is configured for selectively compressing for applying pressure to said shaving aid.

15. The assembly of claim 3, further including a nipple coupled to an upper end of said sleeve, wherein said nipple is positioned on said sleeve such that said first pipe is configured for inserting said nipple for coupling said sleeve to said housing.

16. The assembly of claim 4, comprising:
said inner circumference being non-circularly shaped;
said actuator comprising:
a cutout extending into said tube from said inner circumference proximate to said first end, said cutout extending annularly around said inner circumference, said cutout being circularly shaped,
a first disk positioned in said cutout such that said first disk is rotatable relative to said tube,
a rod coupled to and extending from said first disk into said interior space, said rod being threaded,
a second disk substantially complementary to said inner circumference of said tube,
an orifice centrally positioned through said second disk, said orifice being threaded such that said orifice is complementary to said rod, said rod being threadedly inserted through said orifice,
a cylinder coupled to and extending from said first disk through said first end of said tube, and
a knob coupled to said cylinder distal from said first disk such that said knob is external to said tube; and
wherein said knob is positioned on said cylinder such that said knob is configured for grasping in digits of the hand of the user for selectively imparting rotation to said knob concurrent with rotation of said cylinder, said first disk, and said rod, such that said second disk is selectively positionable between said first end and said second end of said tube for applying pressure to said shaving aid positioned in said sleeve such that said shaving aid is motivated through said first channel, said second channel, and said shell for applying said shaving aid to the skin surface.

17. The assembly of claim 16, further including said inner circumference be ovally shaped.

18. The assembly of claim 16, further including said rod having a terminus distal from said first disk, said terminus being rounded such that said sleeve is deformable around said rod as said sleeve is inserted into said interior space.

19. The assembly of claim 1, further including said tube having an outer circumference, said outer circumference being larger proximate to said first end defining a protuberance, wherein said protuberance is positioned on said tube such that said protuberance is configured for deterring slippage of a hand grasping said tube.

20. A shaving aid dispensing razor assembly comprising:
a tube defining an interior space, said tube have a first end and a second end, said first end being closed, said second end being open, said tube having an inner circumference, said inner circumference being non-circularly shaped, said inner circumference be ovally shaped, said inner circumference being circularly shaped adjacent to said second end, said tube being internally threaded adjacent to said second end, said tube having an outer circumference, said outer circumference being larger proximate to said first end defining a protuberance, wherein said protuberance is positioned on said tube such that said protuberance is configured for deterring slippage of a hand grasping said tube;
a housing having a bottom selectively couplable to said second end of said tube;
a first channel extending between a top and said bottom of said housing such that said first channel is aligned with said second end of said tube;
a first pipe coupled to and extending from said bottom of said housing, said first pipe being aligned with said first channel such that said first pipe is in fluidic communication with said first channel, said first pipe being externally threaded such that said first pipe is positioned for threadedly inserting into said second end of said tube for reversibly coupling said housing to said tube and such that said housing is in fluidic communication with said first channel;
a plurality of first couplers coupled to said top of said housing, said plurality of first couplers comprising two said first couplers, each said first coupler comprising a slot extending into said top of said housing;
a plurality of cutting modules, each said cutting module being selectively couplable to said second end of said tube such that said cutting module is in fluidic communication with said interior space, said cutting modules being selectively couplable to said top of said housing such that said cutting module is in fluidic communication with said first channel, each said cutting module comprising:
a shell defining an internal space,
an aperture positioned in a front face of said shell, said plurality of cutting modules comprising a first module and a second module, said front face of said shell of said first module being substantially planar, said front face of said shell of said second module being concavely arcuate,
a plurality of blades, each said blade being coupled to said shell and positioned in said internal space such that a cutting edge of said blade protrudes from said front face through said aperture, said blades being parallel planarly positioned, said plurality of blades comprising from one to five said blades, said plurality of blades comprising from two to four said blades, said plurality of blades comprising four said blades, each said cutting edge of said plurality of blades positioned in said shell of said second module being arcuate such that said plurality of blades is complementary to said front face of said shell of said second module,
a bar having a first face coupled to a back face of said shell, said bar having a second face configured for coupling to said top of said housing, said housing and bar being arcuate such that said housing and said bar are curvedly positioned between said tube and said back face of said shell,
a second channel extending through said bar and between said first face and said second face, wherein said second channel is positioned through said bar such that said second channel is aligned with said first channel when said bar is coupled to said housing such that said internal space said shell is in fluidic communication with said interior space of said tube,
a plurality of second couplers coupled to said second face of said bar, said second couplers being complementary to said first couplers, wherein said second couplers are positioned on said bar such that each said second coupler is positioned for selectively coupling to a respective said first coupler for coupling said bar to said housing, each said second coupler comprising a tab, said tab being resilient such that said tab is deformable, said tab being L-shaped, wherein said tabs are positioned on said bar such that each said tab is positioned for selectively inserting into a respective said slot for coupling said bar to said housing, and
a second pipe coupled to and extending from said second face of said bar, said second pipe being complementary to said first channel, wherein said second pipe is positioned on said bar such that said second pipe is positioned for sealably inserting into said first channel as said bar is coupled to said housing such that said internal space of said shell is in fluidic communication with said interior space of said tube;
a shaving aid positioned in said interior space, said shaving aid being positioned in a sleeve, said sleeve being complementary to said interior space, said sleeve being flexible such that said sleeve is configured for selectively compressing for applying pressure to said shaving aid;
a nipple coupled to an upper end of said sleeve, wherein said nipple is positioned on said sleeve such that said first pipe is configured for inserting said nipple for coupling said sleeve to said housing;
an actuator coupled to said tube, said actuator being configured for selectively motivating said shaving aid from said first end to said second end of said tube such that said shaving aid exits through said cutting module, wherein said tube is configured for grasping in the hand of the user positioning the user for positioning a respective said cutting module next to a skin surface to be shaved such that said actuator is positioned for motivating said shaving aid through said second end and said respective said cutting module and for applying said shaving aid to the skin surface, such that the user is positioned for motivating said respective said cutting module across the skin surface for shaving the skin surface, said actuator comprising:
a cutout extending into said tube from said inner circumference proximate to said first end, said cutout extending annularly around said inner circumference, said cutout being circularly shaped,
a first disk positioned in said cutout such that said first disk is rotatable relative to said tube,
a rod coupled to and extending from said first disk into said interior space, said rod being threaded, said rod having a terminus distal from said first disk, said terminus being rounded such that said sleeve is deformable around said rod as said sleeve is inserted into said interior space,
a second disk substantially complementary to said inner circumference of said tube,
an orifice centrally positioned through said second disk, said orifice being threaded such that said orifice is complementary to said rod, said rod being threadedly inserted through said orifice,
a cylinder coupled to and extending from said first disk through said first end of said tube, and
a knob coupled to said cylinder distal from said first disk such that said knob is external to said tube, wherein said knob is positioned on said cylinder such that said knob is configured for grasping in digits of the hand of the user for selectively imparting rotation to said knob concurrent with rotation of said cylinder, said first disk, and said rod, such that said second disk is selectively positionable between said first end and said second end of said tube for applying pressure to said shaving aid positioned in said sleeve such that said shaving aid is motivated through said first channel, said second channel, and said shell for applying said shaving aid to the skin surface;
a strap having opposing endpoints, each said opposing endpoint being coupled to said back face proximate to a respective opposing end of said shell of said second module defining a loop, wherein said strap is positioned on said shell of said second module such that said loop is configured for inserting digits of the hand of the user such that the user is positioned for motivating said plurality of blades positioned in said shell of said second module across the skin surface for shaving the skin surface; and
wherein said tube is configured for grasping in the hand of the user positioning the user for positioning said respective said cutting module next to the skin surface to be shaved, wherein said knob is positioned on said cylinder such that said knob is configured for grasping in the digits of the hand of the user for selectively imparting rotation to said knob concurrent with rotation of said cylinder, said first disk, and said rod, such that said second disk is selectively positionable between said first end and said second end of said tube for applying pressure to said shaving aid positioned in said sleeve such that said shaving aid is motivated through said first channel, said second channel, and said shell for applying said shaving aid to the skin surface, such that the user is positioned for motivating said respective said cutting module across the skin surface for shaving the skin surface.
